(19) United States
(12) Patent Application Publication
(10) Pub. No.: US 2011/0203094 A1
(43) Pub. Date: Aug. 25, 2011

(54) DEVICE FOR REMOVING A SEWAGE LINE CAP

(76) Inventors: Patrick Louis Marciniak, Stephenson, MI (US); Herbert John Peter Goetz, Neenah, WI (US); Mark S. Payne, Neenah, WI (US)

(21) Appl. No.: 13/031,194

(22) Filed: Feb. 19, 2011

Related U.S. Application Data
(60) Provisional application No. 61/307,075, filed on Feb. 23, 2010.

(51) Int. Cl. B23P 19/04

(52) U.S. Cl. 29/426.2; 29/244

(57) ABSTRACT

A device and method for securely removing a sewer cap from a sewer line that may be under pressure is disclosed. The device comprises a tube adapted to tightly fit onto the end tee of the sewer line that contains the cap and a piston containing a handle configured to fit and for movement inside the tube. A discharge port on the tube is adapted to discharge fluids into a container. The piston has a recess adapted to tightly fit over the square protrusion typically present on sewer line caps. To remove the sewer cap, the recess in the piston is threaded onto the protrusion on sewer line cap. The tube is then threaded over the piston and tightened over the end tee of the sewer line. Turning the handle to loosen the handle allows any discharge to safely drain through the discharge port.

### RELATED APPLICATIONS

This application claims priority from provisional application Ser. No. 61307075 filed on Feb. 23, 2010.

### FIELD OF THE INVENTION

The present invention relates to a device for securely removing a cap from a pipe that may be under pressure. More specifically, the present invention relates to a device for securely removing a cap from a sewer line and to a method for utilizing the device for this purpose.

### SUMAMRY OF THE PRESENT INVENTION

In one aspect of the present invention, a device for removing a cap from a sewer line, the sewer line containing a tee end member, the cap having an outer protrusion, the device comprises: a hollow tube having and inside, an open receiving end, a discharge port and an outer end, the receiving end of the cylinder being adapted to tightly fit onto the tee end member, the discharge port being adapted for discharging a fluid by gravity; a piston having a front end and a rear end, the piston being adapted to fit inside the tube, the piston also being adapted for movement inside the tube, the front end of the piston having a recess, the recess being configured to tightly fit onto the protrusion of the cap; and a handle attached to the rear end of the piston.

In another aspect of the present invention, a method for securely removing a sewer cap, comprises: providing the device of the present invention for removing a cap from a sewer line; attaching the recess of the piston onto the outer protrusion of the tee end member; threading the tube onto the piston in a manner that the receiving end of the tube is fitted tightly over the tee end member; providing a container under the discharge port for collecting any discharged fluid; turning the handle in a manner as to engage the protrusion in a direction of loosening the sewer cap; unscrewing the sewer cap and pulling the handle toward the outer end of the tube until the cap clears the discharge port; and collecting any discharged fluid into the container.

These and other features, aspects and advantages of the present invention will become better understood with reference to the following drawings, description and claims.

### BRIEF DESCRIPTION OF THE DRAWINGS

FIG. 1 is an exploded perspective front side view of the device according to an embodiment of the present invention;

FIG. 2 is an exploded perspective rear side view of the device according to an alternate embodiment of the present invention;

FIG. 3 is rear view of the device according to an alternate embodiment of the present invention;

FIG. 4 is an a cross sectional side view of the device according to yet another embodiment of the present invention;

FIG. 5 is a top view of a component of the device according to an embodiment of the present invention;

FIG. 6 is a top view of another component of the device according to an embodiment of the present invention;

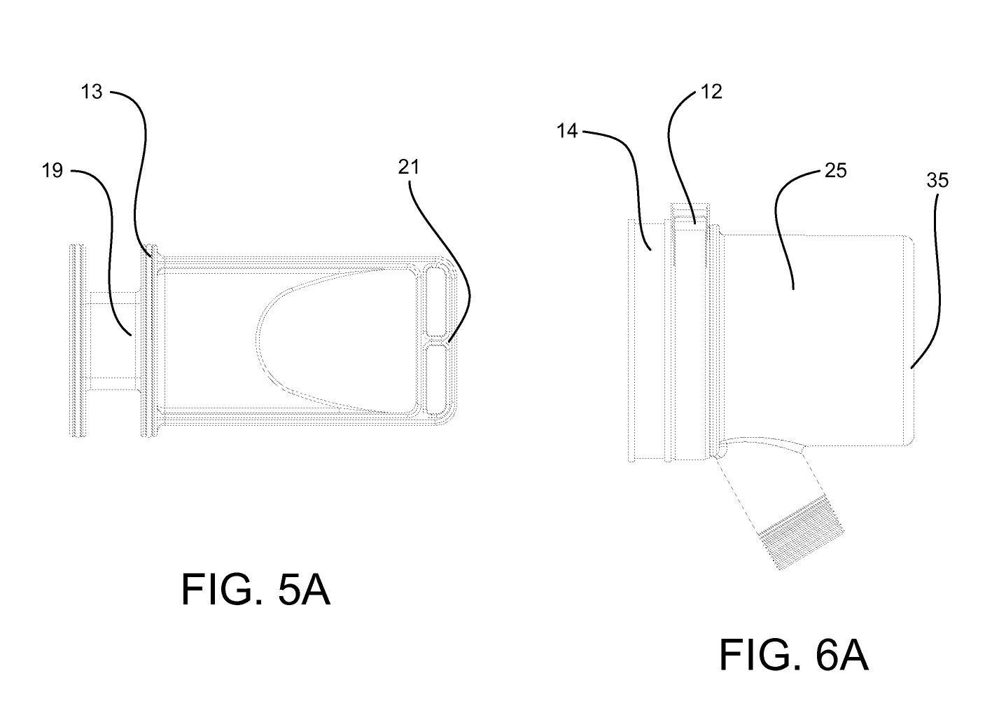

FIG. 5A is a side view of the component of the device in FIG. 5 according to an embodiment of the present invention;

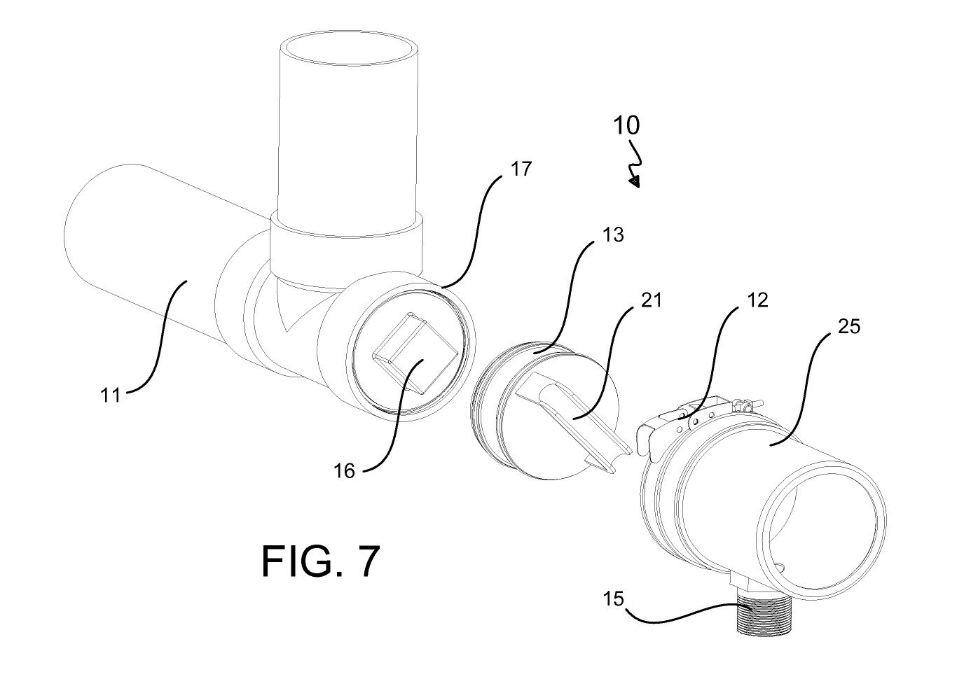

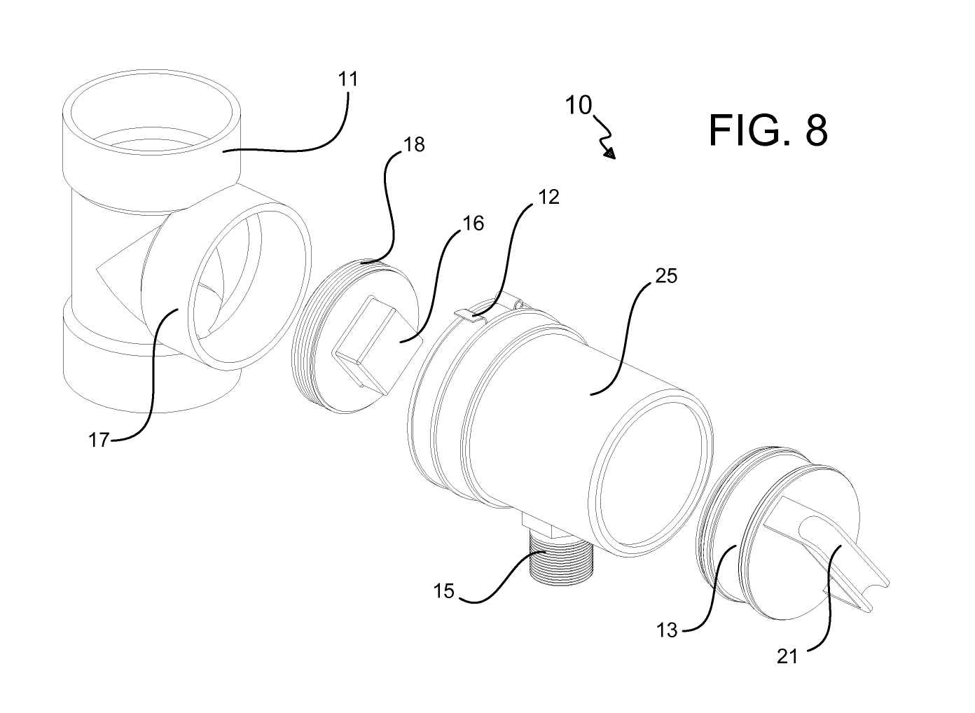

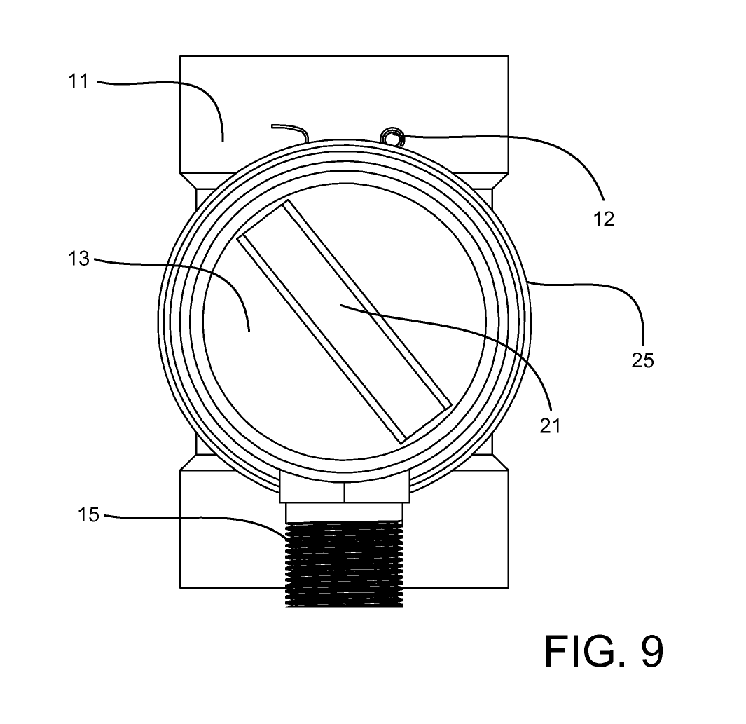

FIG. 6A is a top view of the component of the device in FIG. 6 according to an embodiment of the present invention;

FIG. 7 is a is an exploded perspective rear side view of the device according to another alternate embodiment of the present invention;

FIG. 8 is a is an exploded perspective rear side view of the device according to yet another alternate embodiment of the present invention; and

FIG. 9 is rear view of the device according to another alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present invention relates to a device for removing a cap from a pipe. Pipes that drain sewage from residential or commercial building into a sewer or into a septic tank typically comprise a pipe extension herein referred to as a tee end member, typically located in the basement of the building, which is capped with a removable screw-on cap. The cap may comprise a protrusion adaptable for gripping and turning the cap with a wrench in order to loosen it and remove it if the line is clogged or is suspected of being clogged. When the cap is removed, a plumber may reach in with his/her tools to try to unclog the line. Before loosening the cap, the plumber will generally place a pail or bucket underneath the tee end member opening to contain any spills from the line. However, if the line is under pressure, the sewer discharge port could overshoot the bucket and spill onto the basement floor. This spill then needs to be quickly cleaned up and disinfected as it presents a significant contamination hazard.

The device of the present invention provides a mechanism for containing any spills from the sewer line that can then be disposed of cleanly and safely. The device comprises a cylinder that fastens onto the tee end member at one end. A piston that tightly fits in the cylinder and adapted to move through the cylinder has a depression that tightly fits the cap protrusion, thus enabling it to be used to loosen and remove the cap through the cylinder. Any discharge from the sewer line that would be released after the cap is removed is routed through the cylinder, through a drain line coming off the cylinder and into a container. A gasket insures a tight fit over the tee end member to prevent leaks.

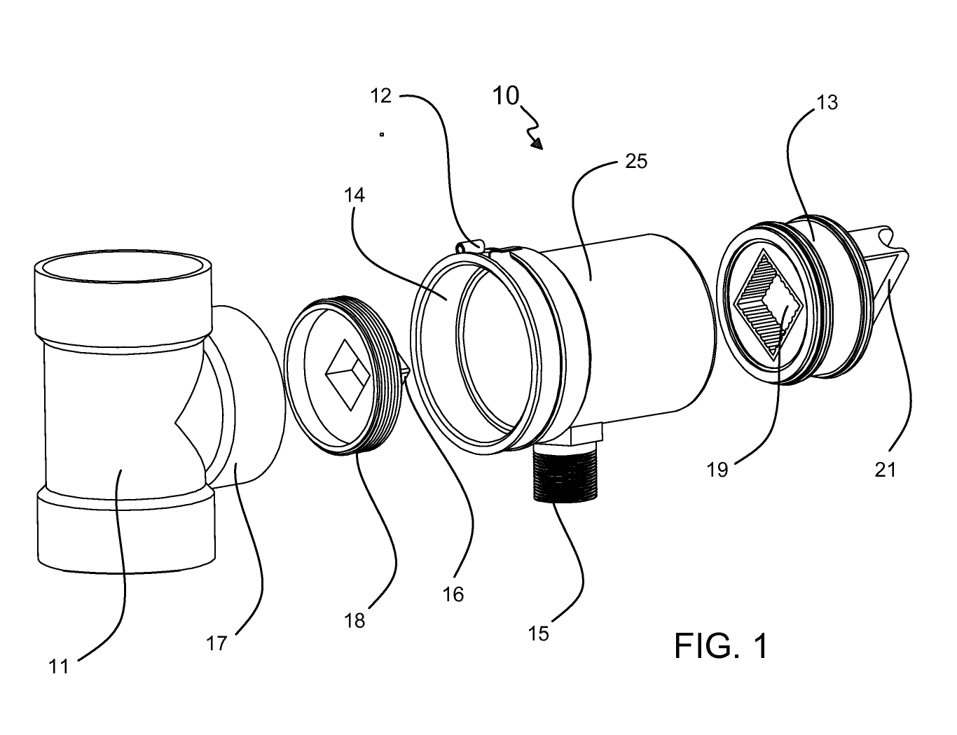

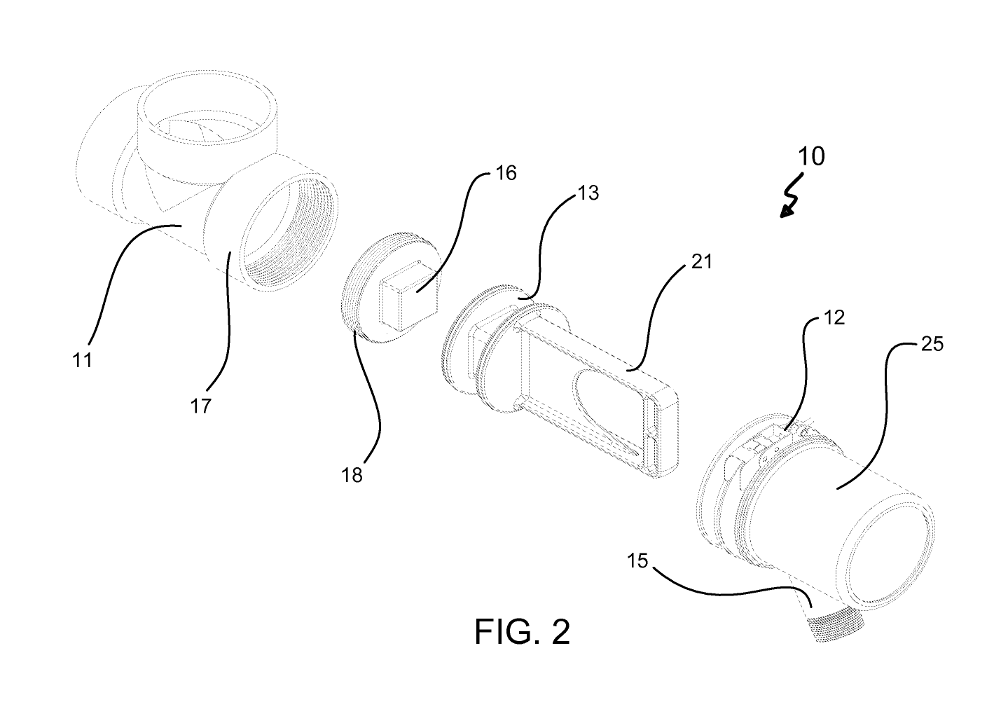

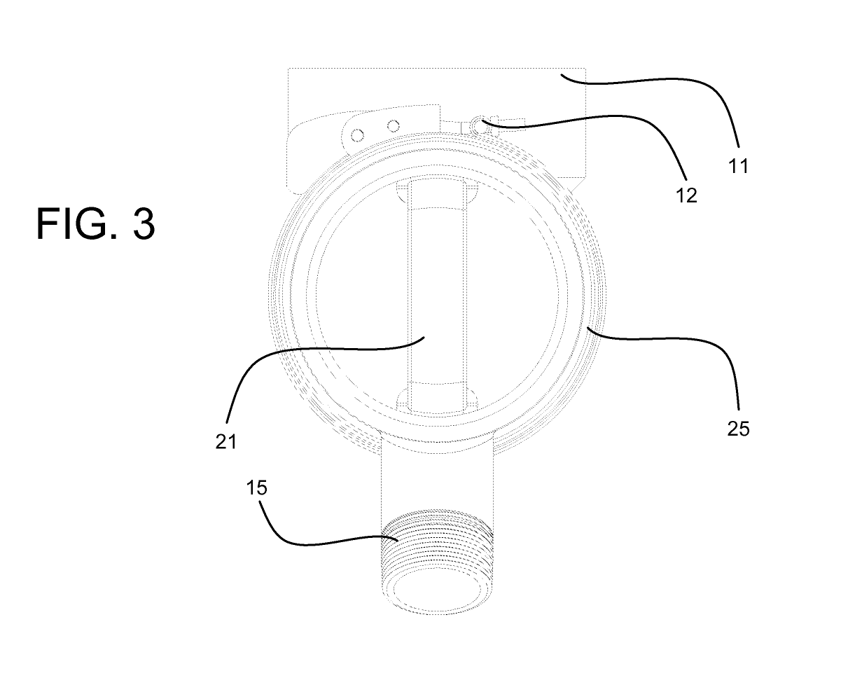

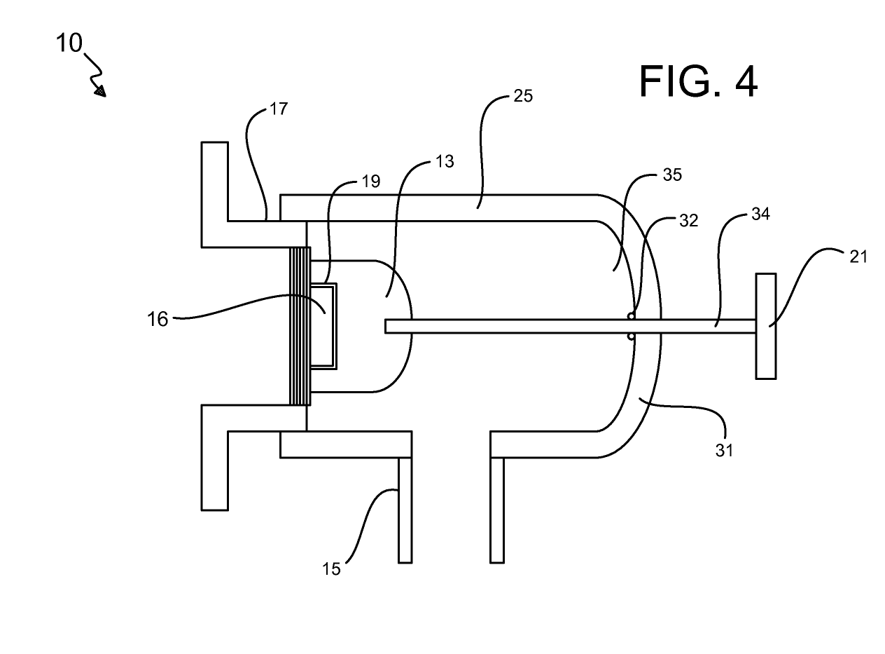

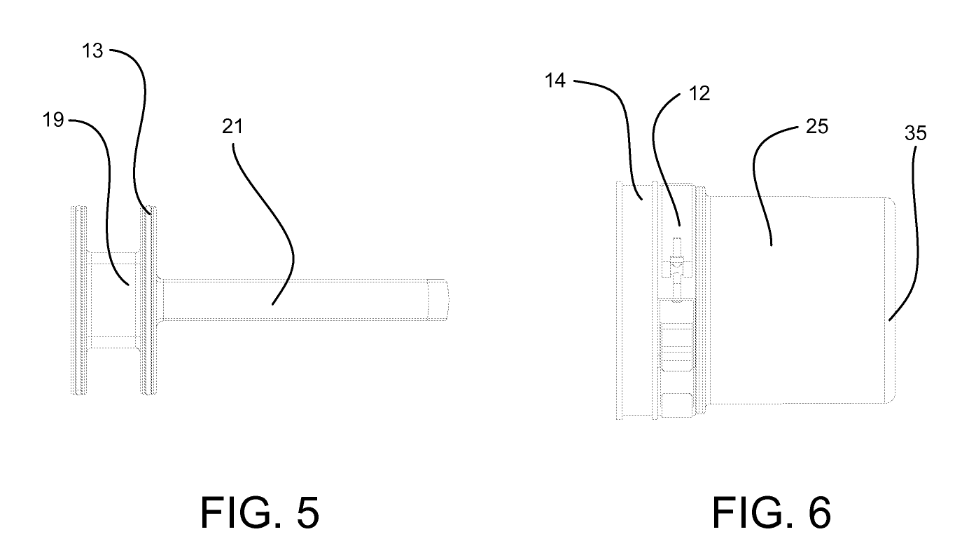

FIGS. 1-7 and 9 illustrate an embodiment of the device 10. Shown is the pipe 11 having an open tee end member 17 onto which a cap 18 is threaded. The cap comprises a protrusion 16 used for gripping with a wrench and unscrewing as needed. While the protrusions 16 tend to be square-shaped, other shapes may be accommodated within the scope of the present invention. The cylinder 25 is hollow and has two open ends. The receiving end of the cylinder discharge comprises a gasket 14 that lines the interior and a clamp 12 disposed on the exterior. This end of the cylinder 25 is configured to fit over the tee end member 17 and the clamp 12 tightens over the tee end member 17 helped by the gasket 14 to provide a good seal that prevents any sewer line discharge from leaking out. The bottom side of the cylinder 25 contains a drain discharge line 15 that leads to a container used for collecting any discharge from the sewer line. The drain line may be a standard 1.5″ size. It should be understood that while a cylinder is the preferred embodiment of the present invention, other tubular shapes such as rectangular also fall within the scope of the present invention.

A piston 13 is adapted for a tight fit inside the cylinder and to slide through the cylinder 25. The piston 13 had a recess 19 on its front side and handle 21 on its back side. The recess 19 is configured to slide over and tightly fit the cap protrusion 16 which is typically square shaped. Thus the recess would typically also be square-shaped.

In an alternate embodiment, the outer end 35 of the cylinder 25 is open and the piston 13 generally needs to fit tightly inside the cylinder 25 to prevent discharge leakage through the cylinder 25. FIG. 8 shows the alternate embodiment of the present invention wherein a rim 31 closes the outer end 35 of the cylinder 25 around the handle rod 34 attached to the piston 13. Gasket 32 seals the opening around the handle rod 34. In this case, the rim 31 and gasket 32 block any discharge through the outer end 35 of the cylinder 25.

The method for using the device begins with the steps of inserting the piston recess onto the protrusion on the cap and attaching the cylinder receiving end onto the tee end member. The handler or plumber would then rotate the piston in the direction of unscrewing the cap and gently loosen it making sure that any pressure in the line is allowed to slowly release. Next, the cap would be unscrewed and pulled back and out of the cylinder. Any discharge from the line would be routed through the cylinder and the drain line into a container where it is collected for later disposal.

It should be understood, of course, that the foregoing relates to exemplary embodiments of the invention and that modifications may be made without departing from the spirit and scope of the invention.

We claim:

1. A device for removing a cap from a sewer line, said sewer line containing a tee end member, said cap having an outer protrusion, said device comprising:
a hollow tube having and inside, an open receiving end, a discharge port and an outer end, said receiving end of the cylinder being adapted to tightly fit onto said tee end member, said discharge port being adapted for discharging a fluid by gravity;
a piston having a front end and a rear end, said piston being adapted to fit inside the tube, said piston also being adapted for movement inside the tube, said front end of the piston having a recess, said recess being configured to tightly fit onto the protrusion of said cap; and
a handle attached to the rear end of said piston.

2. The device of claim 1, wherein the piston and tube have a cuboid shape.

3. The device of claim 1, wherein the piston and tube have a cylindrical shape.

4. The device of claim 1, further comprising a clamp adapted for tightening the open receiving end of the hollow tube onto the tee end member.

5. The device of claim 1, wherein the outer protrusion on the cap and recess on the piston are square shaped.

6. The device of claim 1, further comprising a rim disposed onto the outer end of the tube, said rim having an aperture, said handle of the piston being configured for passing through said aperture.

7. The device of claim 6, further comprising a gasket disposed around the aperture inside the tube.

8. A method for securely removing a sewer cap, said method comprising:
providing a device for removing a cap from a sewer line, said sewer line containing a tee end member, said cap having an outer protrusion, said device comprising: a hollow tube having and inside, an open receiving end, a discharge port and an outer end, said receiving end of the cylinder being adapted to tightly fit onto said tee end member, said discharge port being adapted for discharging a fluid by gravity; a piston having a front end and a rear end, said piston being adapted to fit inside the tube, said piston also being adapted for movement inside the tube, said front end of the piston having a recess, said recess being configured to tightly fit onto the protrusion of said cap; and a handle attached to the rear end of said piston;
attaching the recess of the piston onto the outer protrusion of the tee end member;
threading the tube onto the piston in a manner that the receiving end of the tube is fitted tightly over the tee end member;
providing a container under the discharge port for collecting any discharged fluid;
turning the handle in a manner as to engage the protrusion in a direction of loosening the sewer cap;
unscrewing the sewer cap and pulling the handle toward the outer end of the tube until the cap clears the discharge port; and
collecting any discharged fluid into the container.
